(19) United States
(12) Patent Application Publication
(10) Pub. No.: US 2024/0178417 A1
(43) Pub. Date: May 30, 2024

(54) Fuel Supply Apparatus

(71) Applicant: Norgren Manufacturing Co., Ltd., Shanghai (CN)

(72) Inventors: Yi Liu, Shanghai (CN); Jing Cheng, Shanghai (CN); Yujie Bai, Shanghai (CN)

(21) Appl. No.: 18/549,490

(22) PCT Filed: Apr. 8, 2021
(86) PCT No.: PCT/CN2021/085955

§ 371 Date: Sep. 7, 2023

(30) Foreign Application Priority Data
Mar. 8, 2021 (WO) PCT/CN2021/079578

(51) Int. Cl. H01M 8/04082; H01M 8/04089; H01M 8/0438; H01M 8/04746

(52) U.S. Cl. CPC H01M 8/04201; H01M 8/04097; H01M 8/04388; H01M 8/04753

(57) ABSTRACT

A fuel supply apparatus for a fuel cell system, the apparatus comprising a fuel supply flow path by which fuel is supplied to an inlet of said fuel cell system, wherein the fuel supply flow path comprises a first branch, and a second branch arranged in parallel to the first branch; a fuel recirculation flow path by which residual fuel is transferred from an outlet of said fuel cell system to the fuel supply flow path, wherein the fuel recirculation flow path comprises a first branch and a second branch; a first ejector for introducing recirculated fuel from the first branch of the fuel recirculation flow path to the first branch of the fuel supply flow path; a second ejector for introducing recirculated fuel from the second branch of the fuel recirculation flow path to the second branch of the fuel supply flow path; a first valve for controlling flow at the second branch of the fuel supply flow path, and a second valve for controlling flow at the second branch of the fuel recirculation flow path, wherein the first and second valves each have a first, closed position where flow is prevented and a second, open position where flow is permitted. When said fuel cell system is operated at a first, lower, power rate, the first and second valves are in the first, closed position, such that the introduction of recirculated fuel to the second branch of the fuel supply flow path at the second ejector is prevented; and when said fuel cell system is operated at a second, higher, power rate, the first and second valves are in the second, open position, such that recirculated fuel is introduced to the second branch of the fuel supply flow path at the second ejector.

### TECHNICAL FIELD

The present disclosure relates to a fuel supply apparatus for a fuel cell system, and to a fuel cell system including a fuel supply apparatus.

### BACKGROUND

A typical fuel cell system is configured for use with fuel in the form of a gas such as hydrogen. In such a system, fuel is introduced to the system from a fuel storage tank via a supply manifold. The fuel then enters a fuel cell stack for the generation of electricity. However, not all of the fuel supplied to the fuel cell stack is consumed in the generation of electricity. Such residual fuel is removed from the fuel cell stack, and can be recirculated within the system in order to avoid waste.

The residual fuel must be returned to the fuel supply to the fuel cell stack. It is known to recirculate residual fuel, and to return the residual fuel to the fuel supply, using a pump. Such a recirculation pump requires power and increases the complexity of the system. It is therefore known to reintroduce recirculated residual fuel into the fuel supply by means of an ejector. Whilst this leads to a less complex system, a single ejector is unlikely to be able to meet the requirements of fuel recirculation at all power levels of the fuel cell system.

In addition, the system can remain complex, with multiple components required in order to optimise flow throughout the system. Hysteresis can cause problems, resulting in inaccurate system control.

The present invention aims to address one or more of the above problems.

### SUMMARY OF THE INVENTION

Aspects and embodiments of the invention provide a fuel supply apparatus for a fuel cell system, the apparatus comprising a fuel supply flow path by which fuel is supplied to an inlet of said fuel cell system, wherein the fuel supply flow path comprises a first branch, and a second branch arranged in parallel to the first branch; a fuel recirculation flow path by which residual fuel is transferred from an outlet of said fuel cell system to the fuel supply flow path, wherein the fuel recirculation flow path comprises a first branch and a second branch; a first ejector for introducing recirculated fuel from the first branch of the fuel recirculation flow path to the first branch of the fuel supply flow path; a second ejector for introducing recirculated fuel from the second branch of the fuel recirculation flow path to the second branch of the fuel supply flow path; a first valve for controlling flow at the second branch of the fuel supply flow path, and a second valve for controlling flow at the second branch of the fuel recirculation flow path, wherein the first and second valves each have a first, closed position where flow is prevented and a second, open position where flow is permitted. When said fuel cell system is operated at a first, lower, power rate, the first and second valves are in the first, closed position, such that the introduction of recirculated fuel to the second branch of the fuel supply flow path at the second ejector is prevented. When said fuel cell system is operated at a second, higher, power rate, the first and second valves are in the second, open position, such that recirculated fuel is introduced to the second branch of the fuel supply flow path at the second ejector.

Advantageously, the cost of the fuel supply apparatus is reduced by the use of ejectors rather than a pump in the recirculation of residual fuel, and the complexity of the apparatus is reduced. Recirculation performance is improved by the use of the second ejector only when required, i.e. when the fuel cell system is operated at a higher power rate. The second ejector can be isolated from the apparatus by the first and second valves.

In exemplary embodiments, the fuel supply apparatus further comprises a control system, wherein the fuel supply flow path comprises a proportional valve, and wherein the control system is configured to provide closed loop control of the proportional valve.

Closed loop control of the proportional valve advantageously reduces hysteresis and improves linearity of flow through the proportional valve.

In exemplary embodiments, the fuel supply apparatus further comprises a manifold unit configured to introduce fuel to the fuel supply flow path, wherein the first and second ejectors and the first and second valves are integral to the manifold unit.

Integration of the ejectors and the related valves into the manifold unit provides a compact arrangement and increases ease of installation of these components into the apparatus.

In exemplary embodiments, the fuel supply flow path comprises a proportional valve, and the proportional valve is integral to the manifold unit.

In exemplary embodiments, the fuel supply flow path comprises a first pressure sensor, upstream of the proportional valve, and a second pressure sensor, downstream of the first and second ejectors, and the first and second pressure sensors are integral to the manifold unit.

Integration of further components, i.e. the proportional valve and/or pressure sensors, into the manifold unit further improves ease of installation and so improves efficiency.

In exemplary embodiments, the first ejector and the second ejector are substantially identical to one another.

The use of first and second ejectors in parallel, rather than using one ejector for one system power rate and another ejector for another system power rate, allows ejectors of the same type, with the same size nozzle, to be used interchangeably as the first and second ejectors. The number of different components required by the apparatus is reduced, as is ease of assembly. The complexity of the system is advantageously reduced.

In exemplary embodiments, the first ejector and second ejector are of different capacity.

Ejectors of different capacity arranged in parallel to one another and selectively used at different power rate requirements provide a range of ejector capacity, depending on said power rate requirements.

In exemplary embodiments, the first and second valves are integral to one another.

The arrangement of the second ejector is such that the first and second valves are switched between open and closed positions simultaneously, allowing the first and second valves to form part of the same valve and be operated together. The apparatus is thus advantageously simplified.

In exemplary embodiments, the fuel supply flow path comprises a third branch arranged in parallel to the first and second branches, wherein the fuel recirculation flow path comprises a third branch. In exemplary embodiments, the apparatus further comprises a third ejector for introducing recirculated fuel from the third branch of the fuel recirculation flow path to the third branch of the fuel supply flow path; a third valve for controlling flow at the third branch of the fuel supply flow path, and a fourth valve for controlling flow at the third branch of the fuel recirculation flow path, wherein the third and fourth valves each have a first, closed position where flow is prevented and a second, open position where flow is permitted. When said fuel cell system is operated at the first, lower, power rate, the third and fourth valves are in the first, closed position, such that the introduction of recirculated fuel to the third branch of the fuel supply flow path at the third ejector is prevented. When said fuel cell system is operated at the second, higher, power rate, the third and fourth valves are in the first, closed position, such that the introduction of recirculated fuel to the third branch of the fuel supply flow path at the third ejector is prevented. When said fuel cell system is operated at a third power rate, higher than the first power rate, the third and fourth valves are in the second, open position, such that recirculated fuel is introduced to the third branch of the fuel supply flow path at the third ejector.

Providing a third ejector allows an increased range of flow rate requirements to be met as power consumption of the fuel cell stack varies. For example, all three ejectors could be used simultaneously, or the first and third ejectors could be used in combination, or the first and second ejectors could be used in combination.

In exemplary embodiments, the first and second valves are solenoid valves.

Solenoid valves are advantageously reliable, and simple and quick to operate.

In exemplary embodiments, the second valve is a non-return valve.

Advantageously, the non-return or check valve is simply controlled by fuel flow, and saves power as no electricity is required for operation. The non-return valve effectively prevents gas flowing in the unwanted direction.

In exemplary embodiments, the first valve is positioned on the second branch of the fuel supply flow path upstream of the second ejector.

The first valve being located upstream of the second ejector avoids restriction of the downstream path of the second ejector, whilst allowing control of flow at the second branch of the fuel supply flow path.

In exemplary embodiments, the fuel supply apparatus comprises a valve for controlling flow at the first branch of the fuel recirculation flow path.

Such a valve prevents the first and second ejectors affecting one another when both ejectors are in use, i.e. when the fuel cell system is operated at the second, higher, power rate.

In exemplary embodiments, the valve for controlling flow at the first branch of the fuel recirculation flow path is a non-return valve.

The valve being a non-return or check valve makes it simple and effective, and allows the first ejector to be operational whenever the fuel cell system is functioning, as recirculated fuel flow to the first ejector is not prevented.

In exemplary embodiments, one or both of the first ejector and the second ejector is a multi-stage ejector

In exemplary embodiments, one or both of the first ejector and the second ejector is a two-stage ejector.

Such a multi-stage ejector allows the fuel supply apparatus to be optimised for a particular application.

There is further provided a fuel cell system comprising a fuel supply apparatus as set out above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments will now be described, by way of example only, with reference to the accompanying drawings, in which:

FIG. 1 is a circuit diagram of a fuel supply apparatus for a fuel cell system according to the present teachings;

FIG. 2 is a perspective view of a manifold unit for the fuel supply apparatus of FIG. 1;

FIG. 3 is a further perspective view of the manifold unit of FIG. 2;

FIG. 4 is an exploded view of the manifold unit of FIGS. 2 and 3;

FIG. 5 is a front view of the manifold unit of FIGS. 2-4;

FIG. 6 is a cross sectional view through the manifold unit for FIGS. 2-5 at A:A, shown in FIG. 5;

FIG. 7 is a perspective view of a further manifold unit according to the present teachings;

FIG. 8 is a further perspective view of the manifold unit of FIG. 7;

FIG. 9 is an exploded view of the manifold unit of FIGS. 7 and 8;

FIG. 10 is a front view of the manifold unit of FIGS. 7-9;

FIG. 11 is a detail cross-sectional view through the manifold unit of FIGS. 7-10 at B:B, shown in FIG. 10;

FIG. 12 is a circuit diagram of a further fuel supply apparatus for a fuel cell system according to the present teachings;

FIG. 13 is a perspective view of a manifold unit for the fuel supply apparatus of FIG. 12;

FIG. 14 is an exploded view of the manifold unit of FIG. 13;

FIG. 15 is a front view of the manifold unit of FIGS. 13 and 14;

FIG. 16 is a cross-sectional view through the manifold unit of FIGS. 13 to 15 at C:C; and

FIG. 17 is a cross-sectional view through a further manifold unit according to the present teachings.

### DETAILED DESCRIPTION

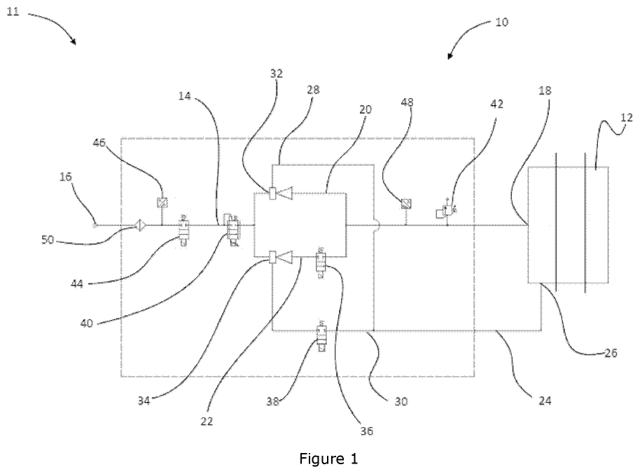

The circuit diagram of FIG. 1 shows a fuel supply apparatus for a fuel cell system 11 indicated generally at 10. The fuel used in the described fuel cell system is in the form of hydrogen supplied as a gas. However, the fuel supply apparatus is suitable for or can be adapted for other types of fuel cell.

The fuel supply apparatus 10 has a fuel supply path 14. Fuel enters the fuel supply apparatus 10 from a fuel storage tank 16, and passes along the fuel supply flow path 14 to an inlet 18 of a fuel cell stack 12. In this embodiment, the fuel cell stack is in the form of a hydrogen fuel cell stack 12. The fuel supply flow path 14 has a first branch 20 and a second branch 22 arranged in parallel to one another.

The fuel supply apparatus 10 has a fuel recirculation flow path 24 for the transfer of residual fuel from an outlet 26 of the hydrogen flow cell stack 12. Residual fuel from the hydrogen cell stack 12 is introduced to the fuel supply flow path 14 and so returns to the inlet 18 of the cell stack 12, thus reducing waste.

The fuel recirculation flow path 24 has a first branch 28 and a second branch 30. The first branch 28 is arranged to introduce recirculated fuel to the first branch 20 of the fuel supply flow path 14. The second branch 30 of the fuel recirculation flow path 24 introduces recirculated fuel to the second branch 22 of the fuel supply flow path 14.

An ejector 32, 34 is provided at each of the first and second branches 20, 22 of the fuel supply flow path in order to allow the introduction of residual fuel to the fuel supply flow path 14. A first ejector 32 is provided on the first branch 20 of the fuel supply path, and a second ejector 34 is provided on the second branch 22 of the fuel supply flow path. Recirculation of residual fuel can thus advantageously take place without the need of a pump, reducing the complexity and the cost of the fuel supply apparatus 10.

When the fuel supply apparatus 10 is active, and fuel is transferred from the storage tank 16 to the fuel cell inlet 18 via the fuel supply flow path 14, the first branch 20 of the fuel supply flow path is constantly in use, i.e. fuel can pass along the fuel supply flow path 14 via the first branch 20 thereof. Similarly, when the fuel supply apparatus 10 is active, the first branch 28 of the fuel recirculation flow path is constantly open, and is used for the introduction of residual fuel to the fuel supply flow path 14.

The fuel supply apparatus 10 has first 36 and second 38 valves for controlling flow of the second branch 22 of the fuel supply flow path and the second branch 30 of the fuel recirculation flow path respectively. In this embodiment, the first and second valves 36, 38 are 2/2-way valves, although alternative suitable valves can be used. As 2/2-way valves, each of the valves 36, 38 has a first, closed position where flow is prevented, and a second, open position, where flow is permitted. When the fuel cell stack 12 is operated at said predetermined lower power rate, no recirculation of fuel through the second branch 30 of the fuel recirculation flow path is required. The valves 36, 38 are in a closed position, such that the second ejector 34 is isolated from the circuit—the flow of fuel along the second branch 30 of the fuel recirculation flow path and the second branch 22 of the fuel supply flow path is prevented. Fuel supply and fuel recirculation is carried out through the first branches 20, 28 alone, as described above.

In this embodiment, the first valve 36 of the second branch 22 of the fuel supply flow path 14 is positioned downstream of the second ejector 34. In alternative embodiments, described in further detail below, the first valve of the second branch of the fuel supply flow path is positioned upstream of the second ejector.

When the fuel cell stack 12 is operating at a predetermined lower power rate, this route is sufficient for the recirculation of residual fuel to the fuel supply flow path 14. However, when the fuel cell stack 12 is operated at a predetermined higher power rate, the fuel requirement of the fuel cell stack 12 is increased, as is the amount of residual fuel expelled from the fuel cell stack 12, so that the flow requirement of the fuel supply apparatus 10 is increased.

At such a time, the valves 36, 38 are moved to an open position, so that the second ejector 34 is no longer isolated from the circuit. Fuel can then flow along the second branch 22 of the fuel supply path 14 as well as the first branch 20 to reach the fuel cell stack inlet 18. Fuel can flow along the second branch 30 of the fuel recirculation flow path 24 as well as via the first branch 28, to reach the fuel supply path 14 via the respective ejectors 32, 34. Both of the ejectors 32, 34 are in use, and fuel flow rate (of both fuel supply and fuel recirculation) is thus increased. Advantageously, the increase in fuel flow rate is carried out simply, by the operation of two 2/2-way valves.

In alternative embodiments, the first and second valves are integral to one another. That is, a single valve is used to shut off and open the second branches of the fuel supply and fuel recirculation flow paths, so that the second ejector can be isolated from the circuit by operation of a single valve. In one embodiment, the single valve is a 4/2-way valve where, in a first position, all four ports are blocked and flow through the valve in any direction is prevented. In a second position, all ports are open, and flow through the valve is permitted.

The fuel supply flow path 14 has a proportional valve 40 upstream of the division of the fuel supply flow path 14 into first and second branches 20, 22. The fuel supply apparatus 10 has a control system 45 for controlling flow via the proportional valve 40. In this embodiment, the control system 45 uses CAN communication to operate the proportional valve 40 using closed loop control. Using closed loop control enables precision control of the proportional valve 40, and advantageously reduces hysteresis. Linearity error is also reduced, i.e. the difference between the output value in test data and the ideal data at a particular command signal is reduced.

In alternative embodiments, the proportional valve is positioned elsewhere in the fuel supply apparatus, or outside the fuel supply apparatus.

The fuel supply apparatus 10 also has a pressure relief valve 42. The pressure relief valve 42 is in this embodiment located on the fuel supply flow path 14. In this embodiment the pressure relief valve 42 is located downstream of the division of the fuel supply flow path into first and second branches 20, 22. In alternative embodiments, the pressure relief valve is located elsewhere in the fuel supply apparatus 10.

The fuel supply apparatus 10 has a 2/2-way operating valve 44 located on the fuel supply flow path 14 upstream of the division of the fuel supply flow path into first and second branches 20, 22. The operating valve 44 is moveable between open and closed positions corresponding to activation or deactivation of the fuel supply apparatus 10, i.e. when the operating valve 44 is in a closed position, the fuel supply apparatus 10 is non-operational. When the operating valve 44 is in an open position, the fuel supply apparatus 10 is operational, and fuel is supplied to the fuel cell stack 12 via the fuel supply flow path 14. In this embodiment, the operating valve 44 is in the form of a solenoid valve 44. In alternative embodiments, alternative suitable valves are used.

The fuel supply apparatus has first 46 and second 48 pressure sensors on the fuel supply flow path 14. The first pressure sensor is upstream of the operating valve 44, and so detects the pressure of fuel entering the fuel supply apparatus 10 from the fuel storage tank 16. The second pressure sensor 48 is downstream of the first and second branches 20, 22. The second pressure sensor thus detects the fuel pressure before the fuel reaches the inlet 18 of the fuel cell stack 12.

The fuel supply apparatus 10 has a filter 50 for filtering fuel as it enters the fuel supply apparatus 10 from the fuel storage tank 16. To this end, the filter 50 is positioned on the fuel supply flow path 14 upstream of the operating valve 44. In this embodiment, the first pressure sensor 46 is downstream of the filter 50.

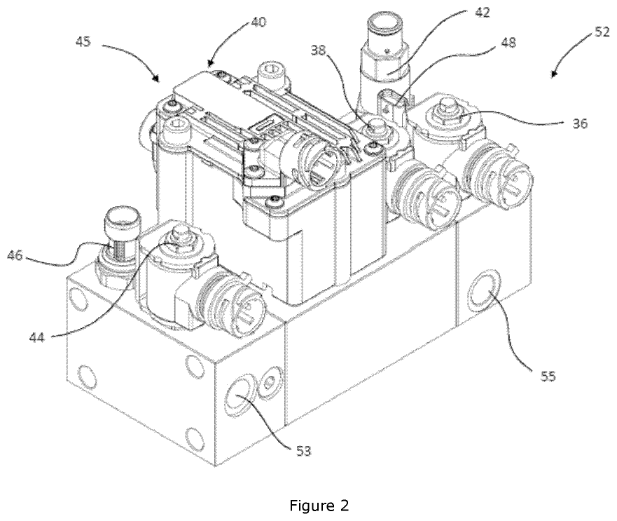

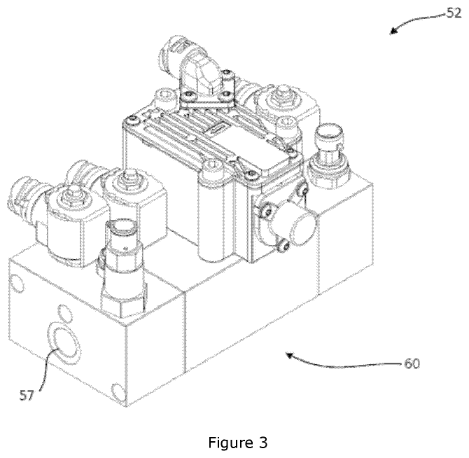

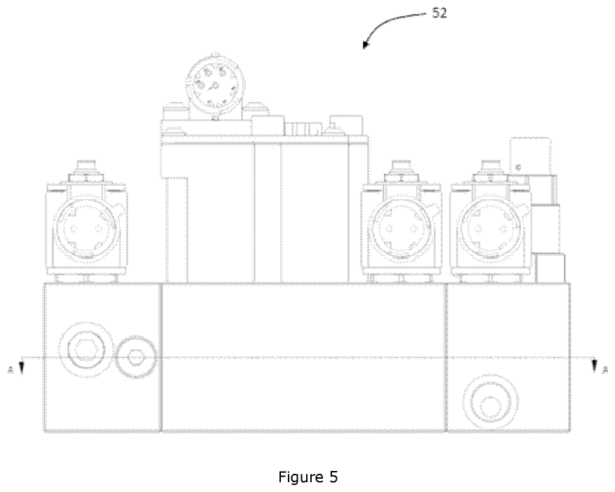

As shown in FIGS. 2-6, the fuel supply apparatus 10 of this embodiment is arranged in a modular manifold unit 52. The component parts of the fuel supply apparatus 10 are attached to or held within the modular manifold unit 52, so that the fuel supply apparatus 10 is quick and simple to install.

Fuel from the fuel storage tank 16 enters the manifold unit 52 at an inlet port 53, within which the filter 50 is supported. Fuel leaves the manifold unit 52 at an outlet port 55, before reaching the inlet 18 of the fuel cell stack 12 (see FIG. 1). Residual recirculated fuel expelled from the fuel cell stack 12 enters the manifold unit 52 at a recirculation port 57.

In this embodiment, the first and second ejectors 32, 34, the first and second valves 36, 38 and the proportional valve 40, together with the control system 45, are integral to the manifold unit 52. That is, those components are supported on, secured to and/or held within a body 60 of the manifold unit 52.

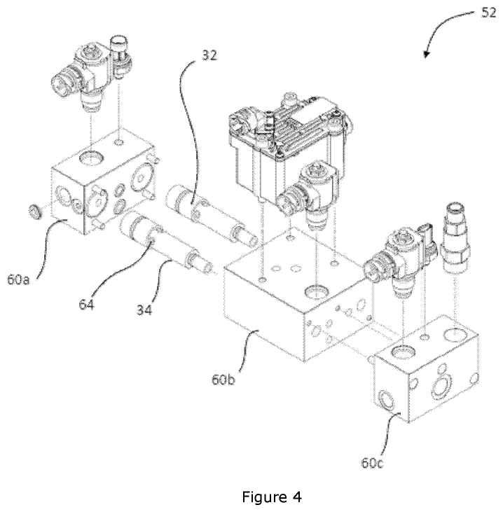

As shown in FIG. 4, in this embodiment, the body 60 of the manifold unit 52 is made up of three portions 60a, 60b, 60c. Each portion 60a, 60b, 60c defines apertures configured to receive the components of the fuel supply apparatus. The central portion 60b defines two receiving portions 61 configured to receive the ejectors 32, 34 such that the ejectors 32, 34 are held within the body 60. The portions 60a, 60b, 60c define projections and corresponding location apertures for easy and quick assembly. In alternative embodiments, the body 60 of the manifold unit 52 is made up of fewer than, or more than, three portions.

In this embodiment, the operating valve 44, the pressure sensors 46, 48, the filter 50 and the pressure relief valve 42 are also incorporated within the manifold unit 52. In alternative embodiments, one or more of the operating valve, the pressure sensors, the relief valve and the filter are located elsewhere in the fuel cell system, rather than in the manifold unit.

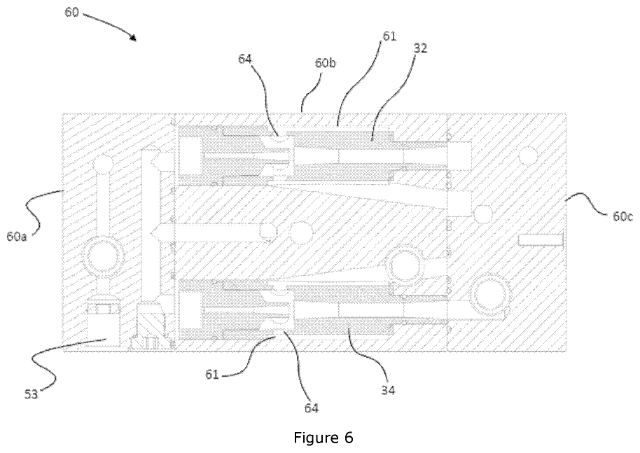

As shown in FIGS. 4 and 6, the first and second ejectors 32, 34 are of the same design. That is, the first and second ejectors are identical to one another, and have identical flow capacity. In alternative embodiments, the first and second ejectors are substantially identical to one another, and have substantially identical flow capacity. The use of the ejectors in parallel in response to the fuel cell stack operating a said higher power allows such identical components to be used—the fuel flow rate of the fuel supply apparatus is increased with the use of multiple ejectors, rather than ejectors of difference size/capacity. The nozzle dimensions of the first and second ejectors 32, 34 can be the same.

In this embodiment, each of the first and second ejectors 32, 34 are single stage ejectors. As shown in FIGS. 4 and 6, each of the first and second ejectors 32, 34 has a first set of suction ports 64 arranged around the perimeter of the ejector 32, 34 by which recirculated fuel enters each ejector 32, 34.

The number of different components used in the flow supply apparatus 10 is therefore reduced, so reducing the complexity of assembly, as either ejector can be fitted in either position.

In alternative embodiments, as described in further detail below, the first and second ejectors are different to one another.

Although in the described embodiments first and second ejectors are provided, it is possible to adjust the fuel flow rate of the fuel supply apparatus by including further ejectors and related valves for isolating said ejector from the circuit. For example, in one embodiment, a third ejector is provided. In such an embodiment, the fuel supply flow path has a third branch, and the fuel recirculation flow path has a third branch, such that residual fuel can be recirculated from the fuel cell stack outlet to the fuel supply flow path via three ejectors simultaneously, or via two ejectors (either the first and third ejector or the first and second ejector) simultaneously, or by the first ejector alone as described above. An even greater range of fuel flow rate is thus provided. In such an embodiment, the third ejector can again be identical, or substantially identical, to the first and second ejectors.

In this embodiment, the first and second valves 36, 38 as well as the operating valve 44, are solenoid valves. In alternative embodiments, the valves are some other suitable valve type, e.g. electric ball valves, direct poppet valves, or spool valves).

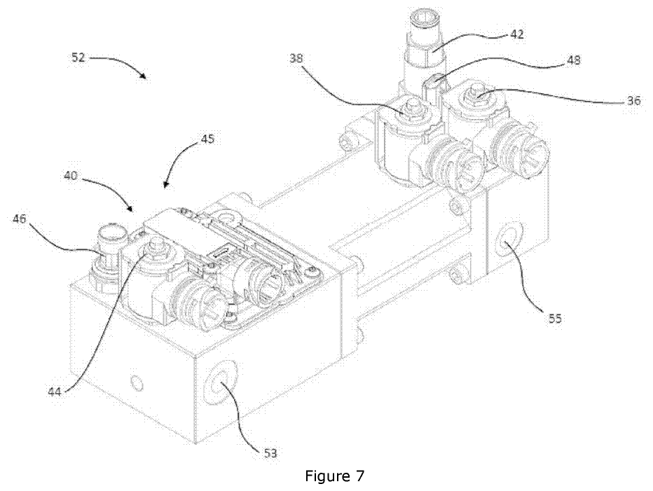

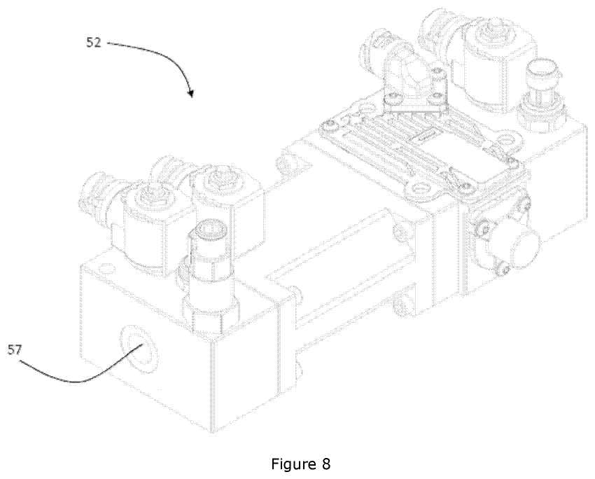

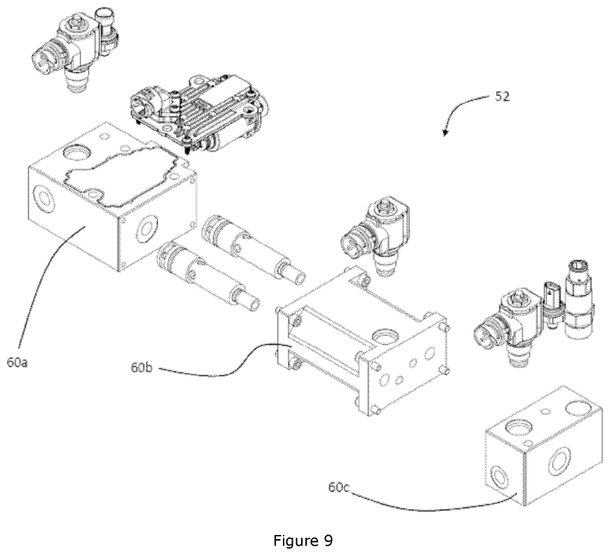

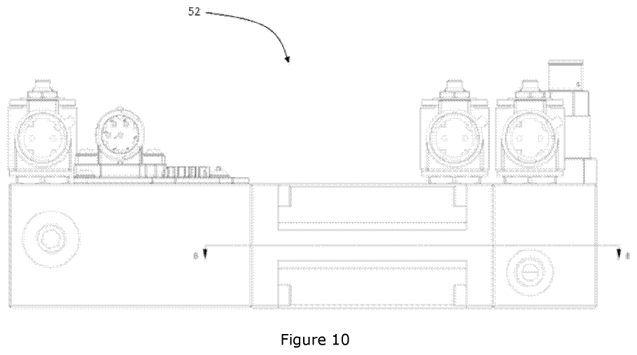

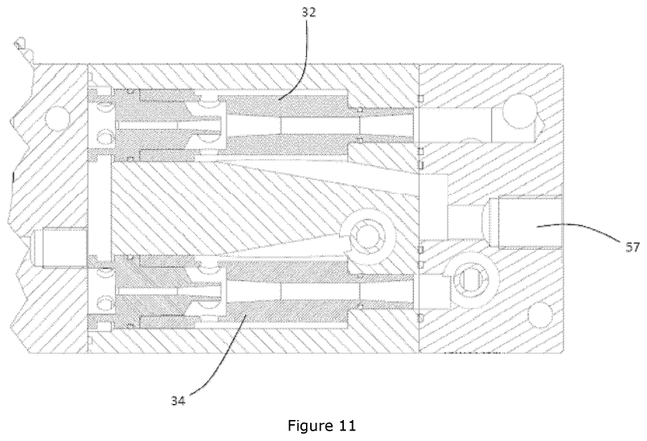

FIGS. 7-11 show a manifold unit 52 of an alternative layout. Again, the first and second ejectors 32, 34, the first and second valves 36, 38 and the proportional valve 40, together with the control system 45, are incorporated in the manifold unit 52. In this embodiment, the operating valve 44, the pressure sensors 46, 48, the filter 50 and the pressure relief valve 42 are also incorporated within the manifold unit 52. In alternative embodiments, one or more of the operating valve, the pressure sensors, the relief valve and the filter are located elsewhere in the fuel cell system, rather than in the manifold unit. As in the previous embodiment, the fuel supply apparatus 10 can be quickly and easily installed.

The layout of the manifold unit can be adjusted in multiple ways to suit the particular application of the fuel supply apparatus. Likewise, the ejector design can be altered, e.g. the nozzle diameter can be altered, depending on the fuel flow rate requirements of the fuel supply apparatus and the pressure ranges involved. In alternative embodiments, the nozzle dimensions of the first and second ejectors are different to one another, in order to meet required fuel power requirements. That is, the first and second ejectors are of different flow capacity.

The control of the fuel supply apparatus can be adjusted to suit particular applications using the control system 45.

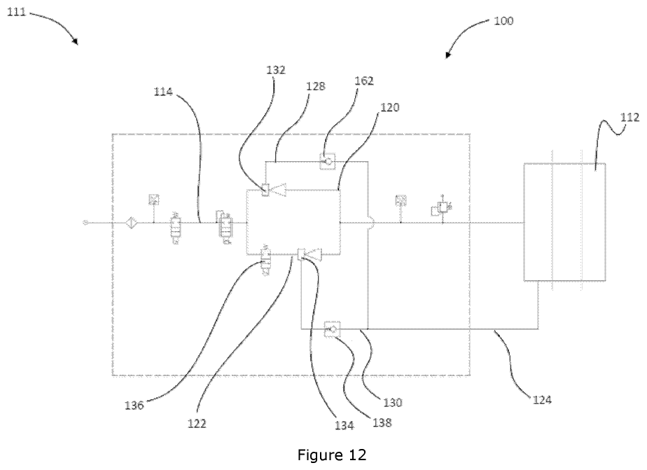

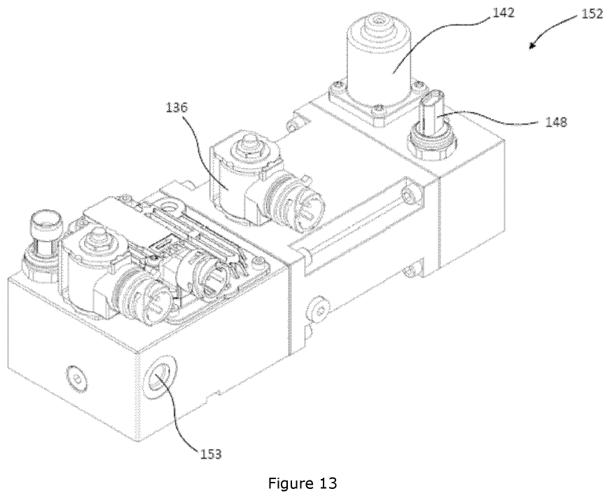

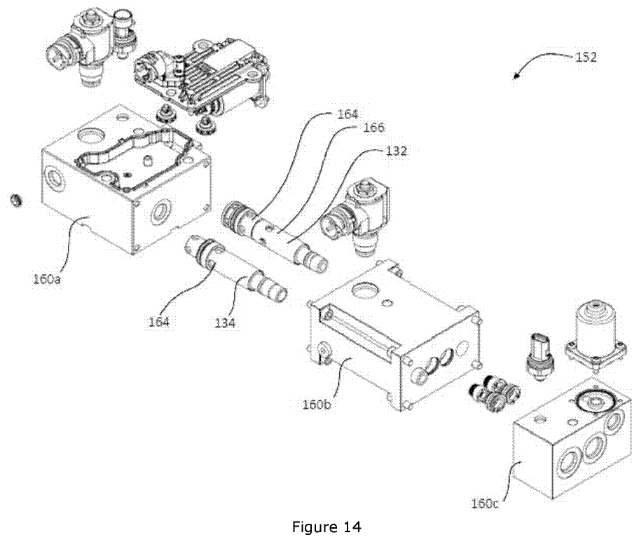

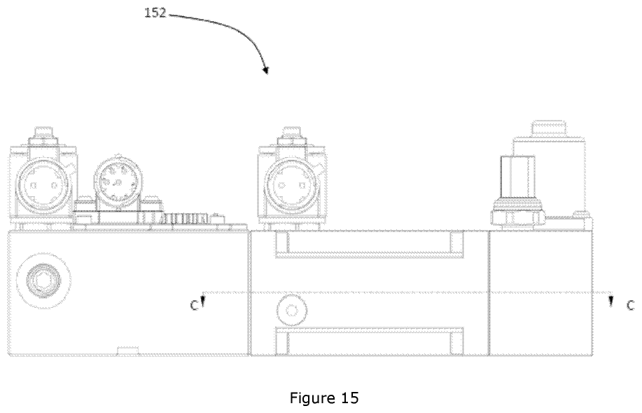

Referring now to FIGS. 12 to 16, a further embodiment is shown. Only differences to the previous embodiments are described in detail. Components corresponding to those of previous embodiments are indicated with like reference numbers, with an additional preceding ‘1’.

In this embodiment, the second valve 138 of the second branch 130 of the fuel recirculation path 124 is a check or non-return valve 138. The non-return valve 138 prevents flow along the second branch 130 of the fuel recirculation path 124 in the unwanted direction, i.e. towards the fuel cell stack 112, whilst allowing flow in the desired direction, i.e. towards the second ejector 134. Flow along the second branch 122 of the fuel supply path 114 is controlled by the first valve 136, so that there is no need to prevent flow along the second branch 130 of the fuel recirculation path 124 towards the second ejector 134. Using a non-return valve 138 increases simplicity of control of the fuel supply apparatus 100 and reduces the power required for operation of the apparatus 100, as no electricity is required to open or close the non-return valve 138.

In contrast to the previous embodiments, the first valve 136 of this embodiment is positioned upstream of the second ejector 134 on the second branch of the fuel supply flow path 114. Advantageously, positioning the first valve 136 upstream of the second ejector 134 avoids potential restriction of flow downstream of the second ejector 134. Greater flexibility of design choice of the first valve 136 is provided, as the orifice size of the first valve 136 in relation to the properties of the second ejector 134 need not be taken into consideration.

In this embodiment, an additional valve 162 is provided in the first branch 128 of the fuel recirculation path 124. The valve 162 prevents flow along the first branch 128 of the fuel recirculation path 124 in the unwanted direction, i.e. towards the fuel cell stack 112, whilst allowing flow in the desired direction, i.e. towards the first ejector 132. The valve 162 thus prevents the first and second ejectors 132, 134 affecting one another when both ejectors 132, 134 are in use.

In this embodiment, the valve 162 is a non-return valve 162 that allows flow along the first branch 128 of the fuel recirculation path 124 towards the first ejector 132 whilst preventing flow towards the fuel cell stack 112. Advantageously, using a non-return valve 162 increases simplicity of control of the fuel supply apparatus 100 and limits the power required for operation of the apparatus 100, as no electricity is required to open or close the non-return valve 162.

In an alternative embodiment, the third valve is some other suitable type of valve, such as a 2/2-way solenoid valve.

In this embodiment, as in the previous embodiments, the second ejector 134 is a single stage ejector, with a first set of suction ports 164 arranged around the perimeter of the second ejector 134. In this embodiment, the first and second ejectors 132, 134 are different to one another. The first ejector 132 of this embodiment is a multi-stage ejector with multiple sets of suctions ports 164, 166 by which recirculated fuel enters the ejector 134. The first ejector 132 of this embodiment is a two-stage ejector with a first set of suction ports 164 and a second set of suction ports 166 arranged around the perimeter of the first ejector 132.

The inclusion of a two-stage ejector 132 can advantageously increase suction efficiency.

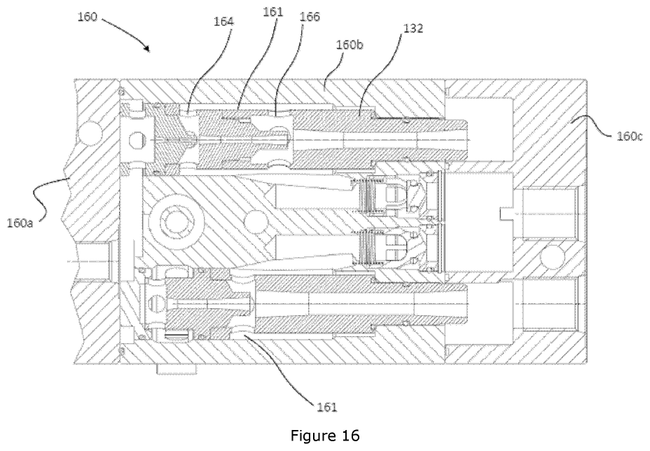

As shown in FIG. 16, the two-stage ejector 132 is received in the receiving portion 161. The receiving portions 161 are each suitable for receiving a multi-stage or single-stage ejector, so that the body 160 of the manifold unit 152 is suitable for use with multi-stage or single stage ejectors.

In an alternative embodiment, the first ejector is a single stage ejector, and the second ejector is a two-stage ejector.

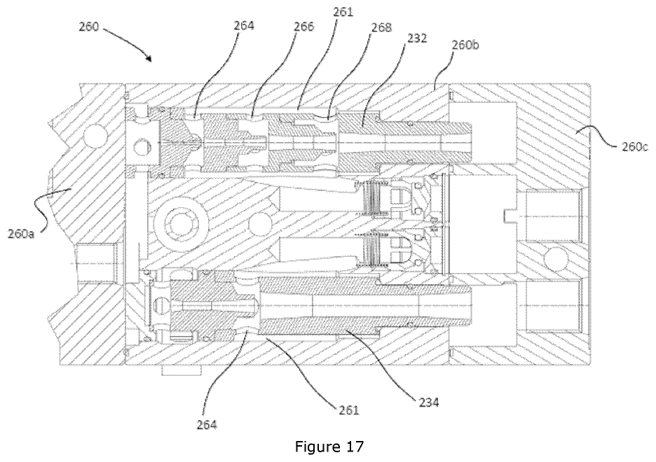

A further embodiment is shown in FIG. 17. As the embodiment is similar to the previous embodiments, only differences with the previous embodiments are described in detail. Components corresponding to those of previous embodiments are indicated with like reference numbers, with an additional preceding ‘2’.

In this embodiment, as in the previous embodiments, the second ejector 234 is a single stage ejector, with a first set of suction ports 264 arranged around the perimeter of the second ejector 234. In this embodiment, the first and second ejectors 232, 234 are different to one another. The first ejector 232 of this embodiment is a multi-stage ejector with multiple sets of suctions ports 264, 266, 268 by which recirculated fuel enters the ejector 234. The first ejector 232 of this embodiment is a three-stage ejector with a first set of suction ports 264, a second set of suction ports 266 and a third set of suctions ports 268 arranged in series around the perimeter of the first ejector 232.

The inclusion of a three-stage ejector 232 can advantageously increase suction efficiency.

As shown in FIG. 17, the three-stage ejector 232 is received in the receiving portion 261. The receiving portions 261 are each suitable for receiving a multi-stage or single-stage ejector, so that the body 260 of the manifold unit is suitable for use with multi-stage or single stage ejectors.

In an alternative embodiment, the first ejector is a single stage ejector, and the second ejector is a three-stage ejector.

In an alternative embodiment, the fuel supply apparatus has ejectors of different numbers of multiple stages, e.g. a two-stage ejector and a three-stage ejector. In alternative embodiments (not shown), the fuel supply apparatus has identical or substantially identical multi-stage ejectors with substantially identical flow capacity. In one alternative embodiment, the fuel supply apparatus has two two-stage ejectors. In one alternative embodiment, the fuel supply apparatus has two three-stage ejectors. In an embodiment with more than two ejectors, the fuel supply apparatus has a combination of ejectors with different numbers of stages, or the fuel supply apparatus has ejectors of the same number of stages.

The fuel supply apparatus above described provides precision control of recirculation of residual fuel. Multiple components of the fuel supply apparatus are incorporated into a single modular unit, improving the ease of installation. The two ejectors are in an arrangement that allows them to be simply controlled to meet different flow rate requirements of the fuel cell system, i.e. depending on the power consumption of the fuel cell stack. Isolation of the second ejector can be simply achieved using the 2/2-way valves, or the 2/2-way valve and the non-return valve.

Hysteresis and the linearity problem of the flow curve is addressed using closed loop control. Overall stability and safety of the system is improved by the control system and proportional valve. The compatibility of the system with various applications is improved by the modular manifold unit arrangement.

1. A fuel supply apparatus for a fuel cell system, the fuel supply apparatus comprising:
a fuel supply flow path by which fuel is supplied to an inlet of said fuel cell system, wherein the fuel supply flow path comprises a first branch, and a second branch arranged in parallel to the first branch;
a fuel recirculation flow path by which residual fuel is transferred from an outlet of said fuel cell system to the fuel supply flow path, wherein the fuel recirculation flow path comprises a respective first branch and a respective second branch;
a first ejector for introducing recirculated fuel from the respective first branch of the fuel recirculation flow path to the first branch of the fuel supply flow path;
a second ejector for introducing recirculated fuel from the respective second branch of the fuel recirculation flow path to the second branch of the fuel supply flow path; and
a first valve for controlling flow at the second branch of the fuel supply flow path, and a second valve for controlling flow at the respective second branch of the fuel recirculation flow path, wherein the first valve and the second valve each has a first, closed position where flow is prevented and a second, open position where flow is permitted,
wherein, when said fuel cell system is operated at a lower, first power rate, the first valve and the second valve are in the first, closed position, such that introduction of recirculated fuel to the second branch of the fuel supply flow path at the second ejector is prevented, and
when said fuel cell system is operated at a higher, second power rate, the first valve and the second valve are in the second, open position, such that recirculated fuel is introduced to the second branch of the fuel supply flow path at the second ejector.

2. The fuel supply apparatus of claim 1, further comprising a control system, wherein the fuel supply flow path comprises a proportional valve, and wherein the control system is configured to provide closed loop control of the proportional valve.

3. The fuel supply apparatus of claim 1, further comprising a manifold unit configured to introduce fuel to the fuel supply flow path, wherein the first ejector and the second ejector and the first valve and the second valve are integral to the manifold unit.

4. The fuel supply apparatus of claim 3, wherein the fuel supply flow path comprises a proportional valve, and wherein the proportional valve is integral to the manifold unit.

5. The fuel supply apparatus of claim 4, wherein the fuel supply flow path comprises a first pressure sensor, upstream of the proportional valve, and a second pressure sensor, downstream of the first ejector and the second ejector and wherein the first pressure sensor and the second pressure sensor are integral to the manifold unit.

6. The fuel supply apparatus of claim 1, wherein the first ejector and the second ejector are substantially identical to one another.

7. The fuel supply apparatus of claim 1, wherein the first ejector and the second ejector are of different capacity.

8. The fuel supply apparatus of claim 1, wherein the first valve and the second valve are integral to one another.

9. The fuel supply apparatus of claim 1, wherein the fuel supply flow path comprises a third branch arranged in parallel to the first branch and the second branch, wherein the fuel recirculation flow path comprises a respective third branch, and wherein the fuel supply apparatus further comprises:
a third ejector for introducing recirculated fuel from the respective third branch of the fuel recirculation flow path to the third branch of the fuel supply flow path; and
a third valve for controlling flow at the third branch of the fuel supply flow path, and a fourth valve for controlling flow at the respective third branch of the fuel recirculation flow path, wherein the third valve and the fourth valve each has a first, closed position where flow is prevented and a second, open position where flow is permitted,
wherein, when said fuel cell system is operated at the lower, first power rate, the third valve and the fourth valve are in the first, closed position, such that the introduction of recirculated fuel to the third branch of the fuel supply flow path at the third ejector is prevented,
when said fuel cell system is operated at the higher, second power rate, the third valve and the fourth valve are in the first, closed position, such that the introduction of recirculated fuel to the third branch of the fuel supply flow path at the third ejector is prevented, and
when said fuel cell system is operated at a third power rate, higher than the first power rate, the third valve and the fourth valve are in the second, open position, such that recirculated fuel is introduced to the third branch of the fuel supply flow path at the third ejector.

10. The fuel supply apparatus of claim 1, wherein the second valve is a non-return valve.

11. The fuel supply apparatus of claim 1, wherein the first valve is positioned on the second branch of the fuel supply flow path upstream of the second ejector.

12. The fuel supply apparatus of claim 1, further comprising a valve for controlling flow at the respective first branch of the fuel recirculation flow path, preferably wherein the valve for controlling flow at the respective first branch of the fuel recirculation flow path is a non-return valve.

13. The fuel supply apparatus of claim 1, wherein one or both of the first ejector and the second ejector is a multi-stage ejector, preferably wherein one or both of the first ejector and the second ejector is a two-stage ejector.

14. A fuel cell system comprising the fuel supply apparatus of claim 1.
